(19) United States
(12) Patent Application Publication
(10) Pub. No.: US 2014/0079319 A1
(43) Pub. Date: Mar. 20, 2014

(54) METHODS FOR ENHANCING IMAGES AND APPARATUSES USING THE SAME

(71) Applicant: HTC Corporation, Taoyuan City (TW)

(72) Inventors: Cheng-Hsien LIN, Taoyuan City (TW); Pol-Lin TAI, Taoyuan City (TW); Chia-Ho PAN, Taoyuan City (TW); Ching-Fu LIN, Taoyuan City (TW); Hsin-Ti CHUEH, Taoyuan City (TW)

(73) Assignee: HTC Corporation, Taoyuan City (TW)

(21) Appl. No.: 13/974,978

(22) Filed: Aug. 23, 2013

Related U.S. Application Data
(60) Provisional application No. 61/703,620, filed on Sep. 20, 2012.

(51) Int. Cl. G06T 5/00

(52) U.S. Cl. CPC G06T 5/007
USPC 382/167

(57) ABSTRACT

An embodiment of an image enhancement method is introduced. An object is detected from a received image according to a object feature. An intensity distribution of the object is computed. A plurality of color values of pixels of the object is mapped to a plurality of new color values of the pixels according to the intensity distribution. Finally, a new image comprising the new color values of the pixels is provided to a user.

### CROSS REFERENCE TO RELATED APPLICATIONS

This application claims the benefit of U.S. Provisional Application No. 61/703,620 filed on Sep. 20, 2012, the entirety of which is incorporated by reference herein.

### BACKGROUND

1. Technical Field

The present invention relates to image enhancement, and in particular to a method for enhancing the facial regions of images and apparatuses using the same.

2. Description of the Related Art

When viewing images, users often pay less attention to small objects. However, the small objects may reveal beauty, and should be emphasized. It is required that camera users emphasize small objects so that they “pop” out of the scene. For example, eyes although occupy a small area of the face, it often captures viewer's attention when looking at a portrait photo. Eyes with clear contrast would make a person look more attractive. Also, it is desirable to remove defects of face area for making skin smooth, such as pore, black dots created by noise, etc. As a result it is desirable to process an image for enhancing visual satisfaction of certain areas.

### BRIEF SUMMARY

In order to emphasize small objects, the embodiments disclose image enhancing methods and apparatuses for increasing the contrast of an image object.

An embodiment of an image enhancement method is introduced. An object is detected from a received image according to an object feature. The intensity distribution of the object is computed. A plurality of color values of pixels of the object is mapped to a plurality of new color values of the pixels according to the intensity distribution. Finally, a new image comprising the new color values of the pixels is provided to the user.

An embodiment of an image enhancement apparatus is introduced. The image enhancement apparatus comprises a detection unit, an analysis unit and a composition unit. The detection unit is configured to receive the image and detect the object according to an object feature. The analysis unit, coupled to the detection unit, is configured to compute the intensity distribution of the object and map a plurality of color values of pixels of the object to a plurality of new color values of the pixels according to the intensity distribution. The composition unit, coupled to the analysis unit, is configured to provide a new image comprising the new color values of the pixels to the user.

A detailed description is given in the following embodiments with reference to the accompanying drawings.

### BRIEF DESCRIPTION OF THE DRAWINGS

The present invention can be fully understood by reading the subsequent detailed description and examples with references made to the accompanying drawings, wherein:

FIG. 1 illustrates the block diagram of a contrast enhancement system according to an embodiment of the invention;

FIG. 2 shows a schematic diagram of an exemplary equalization;

FIG. 3 is a schematic diagram illustrating eye contrast enhancement according to an embodiment of the invention;

FIG. 4 is a schematic diagram illustrating facial skin enhancement according to an embodiment of the invention;

FIG. 5 illustrates the architecture for the hybrid GPU/CPU process model according to an embodiment of the invention;

FIG. 6 is a flowchart illustrating an image enhancement method for enhancing an object within an image according to an embodiment of the invention.

### DETAILED DESCRIPTION

The following description is of the best-contemplated mode of carrying out the invention. This description is made for the purpose of illustrating the general principles of the invention and should not be taken in a limiting sense. The scope of the invention is best determined by reference to the appended claims.

It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

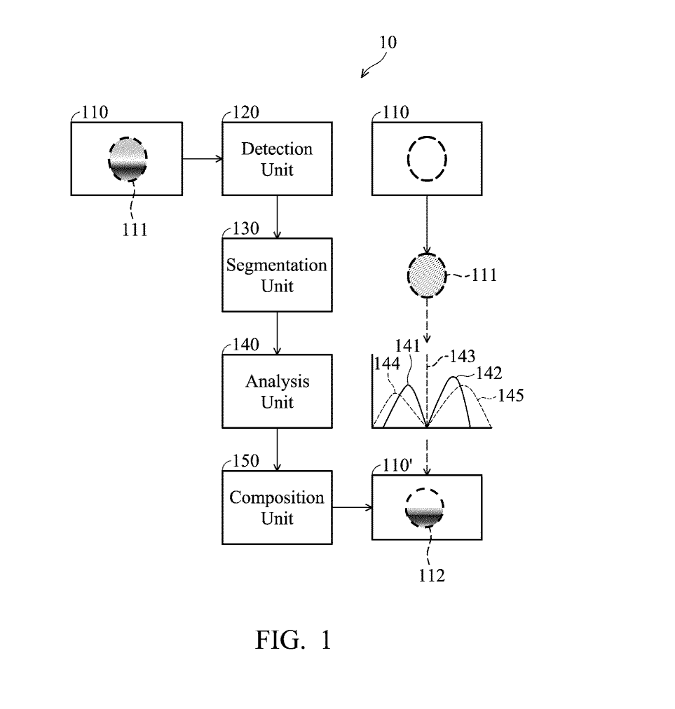

FIG. 1 illustrates the block diagram of a contrast enhancement system according to an embodiment of the invention. The contrast enhancement system 10 comprises at least a detection unit 120 for detecting one or more specified objects 111 presented in the image 110. The object 111 may be a facial feature, such as an eye, a nose, ears, a mouth, or others. The detection unit 120 may analyzes the image 110 in a frame buffer (not shown), which is captured by a camera module (not shown), or in a memory (not shown), tracks how many faces are presented in the image 110 and facial features, such as eyes, a nose, ears, a mouth, or other facial features, for each face, and outputs the facial features to the segmentation unit 130. The camera module (not shown) may comprise an image sensor, such as a CMOS (complementary metal-oxide-semiconductor) or CCD (charge-coupled device) sensor, to detect an image in the form of red, green and blue color strengths, and readout electronic circuits for collecting the sensed data from the image sensor. In other examples, the object may be a car, a flower, or others, and the detection unit 120 may detect the object by various characteristics, such as shapes, color values, or others. When the object 111 is detected, the segmentation unit 130 segments the object 111 from the image 110. The segmentation may be achieved by applying a filter on the pixels of the detected object. Although the shape of the object 111 is an oval in the embodiment shown, it is understood that alternative embodiments are contemplated, such as segmenting an object in another shape, such as a circle, a triangle, a square, a rectangle, or others. The segmentation may crop the object 111 from the image 110 as a sub-image. Information regarding the segmented object, such as pixel coordinates, pixel values, etc., may be stored in a memory (not shown).

The segmented object 111 is then processed to determine its intensity distribution by the analysis unit 140. The analysis unit 140 may, for example, calculate a brightness histogram of the segmented object 111, which provides general appearance description of the segmented object 111, and apply an algorithm to the brightness histogram to find a threshold value 143 that can roughly divide the distribution into two parts 141 and 142. For example, the Otsu's thresholding may be used to find a threshold value that divides the brightness histogram into a brighter part and a darker part. The Otsu's thresholding involves exhaustively searching for the threshold that minimizes the intra-part variance, defined as a weighted sum of variances of the two parts:

σ_{ω}²(t)=ω₁(t)σ₁²(t)+ω₂(t)σ₂²(t) (1)

where, weights ωᵢ are the probabilities of the two parts separated by a threshold t and σᵢ² are variances of these parts. Otsu shows that minimizing the intra-class variance is the same as maximizing inter-class variance:

σ_{b}²(t)=σ²−σ_{ω}²(t)=ω₁(t)ω₂(t)[μ₁(t)−μ₂(t)]² (2)

which is expressed in terms of part probabilities ωᵢ and part means μᵢ. Since many different thresholding algorithms can be implemented for the segmented object 111, the analysis unit 140 does not mandate a particular thresholding algorithm. After finding the threshold, the analysis unit 140 may apply a histogram equalization algorithm to the brighter part and the darker part of the brightness histogram, respectively, to enhance the contrast by redistributing the two parts in wider ranges 144 and 145. Exemplary histogram equalization algorithms are simply described. For the darker part, a given object {X} is described by L discrete intensity levels {X₀, X₁, . . . , X_{L-2}}, where, X₀ and X_{L-2} denote a black level and one level prior to the thresholding level X_{L-1}, respectively. A PDF (probability density function) is defined as:

p(Xₖ)=nₖ/n, for k=0, 1, . . . L−2 (3)

where, nₖ denotes the number of times of a intensity level Xₖ appears in the object {X} and n denotes the total number of samples in the object {X}. And, the CDF (cumulative distribution function) is defined as follows.

$$c ( {X}_{k} ) = {\sum }_{j = 0}^{k} p ( {X}_{k} ) \qquad ( 4 )$$

An output Y of the equalization algorithm with respect to the input sample Xₖ of the given object based on the CDF value is expressed as follows:

Y=c(Xₖ)X_{L-2} (5)

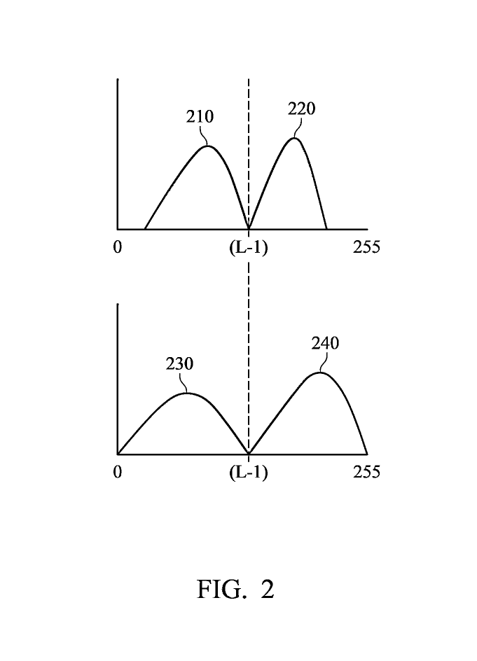

For the brighter part, a given object {X} is described by (256-L) discrete intensity levels {X_{L}, X_{L+1}, . . . , X₂₅₅}, where, X₂₅₅ denotes a white level, and equations (3) to (5) can be modified for k=L, L+1, . . . 255 without excessive effort. The resulting object 112 is therefore obtained. Therefore, by mapping the levels of the input object 111 to new intensity levels based on the CDF, image quality is improved by enhancing the contrast of the object 111. As can be observed in FIG. 2 showing a schematic diagram of an exemplary equalization, the threshold (L−1) serves as a central point and the two original parts 210 and 220 are expanded wider to greater ends as parts 230 and 240, respectively. In the example, the distribution may be expanded by 20% and each of the original intensity values is mapped to a new intensity value, except the threshold value. In some embodiments, the threshold value may be shifted by an offset, and the histogram is redistributed with respect to the shifted threshold. Although the brightness histogram is shown in the embodiment, it is understood that alternative embodiments are contemplated, such as applying the aforementioned thresholding and equalization to a color histogram for a color component, such as Cb, Cr, U, V, or others. The contrast enhancement system may be configured by a user to instruct how the histogram should be processed or redistributed, for example, the maximum level and/or the minimum level can be equalized thereto, or an expanding ratio, or others.

After the brightness histogram is redistributed, the new pixel values are then applied to corresponding pixels of the segmented object to produce an enhanced object 112. The composition unit 150 is used to provide a new image having new color values of the pixels to a user. The composition unit 150 may combine the enhanced object 112 back to the source image to generate an enhanced image 110′. In some embodiments, the composition unit 150 may replace pixel values of the segmented object with the newly mapped values so as to enhance the contrast within the segmented object. The enhanced image 110′ may be displayed on a display unit or stored in a memory or a storage device for a user.

Also, the software instructions of the algorithms illustrated in FIG. 1 may be distributed to one or more processors for execution. The load may be shared between a CPU (central processing unit) and a GPU (graphics processing unit). The GPU or CPU may contain a large number of ALUs (arithmetic logic units) or ‘Core’ processing units. These processing units are capable of being used for massive parallel processing. For example, the CPU may be assigned to perform the object detection and the image composition, while the GPU may be assigned to perform the object segmentation and the brightness histogram calculation. The GPU is designed for the pixel and geometry processing, while the CPU can make logic decisions faster and with more precision, and has less I/O overhead than the GPU. Since the CPU and the GPU have different advantages in image processing, it would be better to leverage the capacity of the GPU in order to enhance overall system performance.

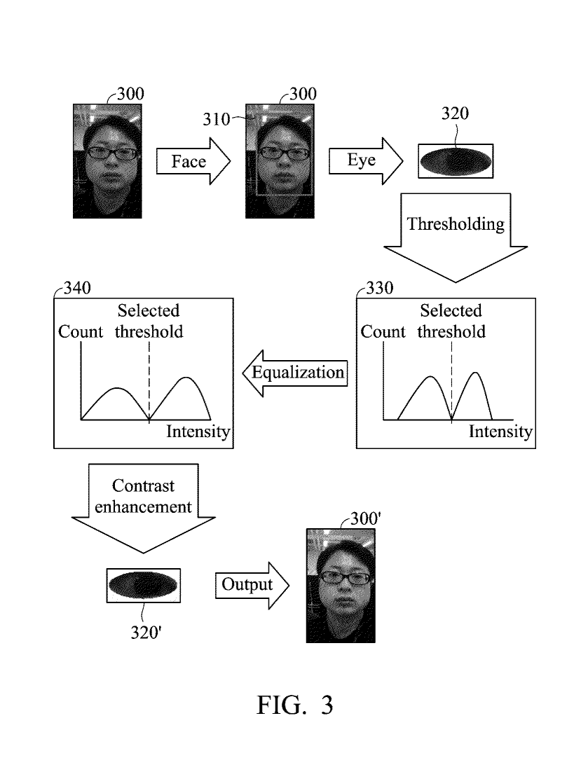

FIG. 3 is a schematic diagram illustrating eye contrast enhancement according to an embodiment of the invention. The face region 310 is first located by analyzing the still image 300, and the eye region 320 is then segmented from the face region 310. The brightness histogram 330 of the eye region 320 is calculated. A thresholding algorithm is applied to the brightness histogram 330 for finding a threshold, which is used to separate the eye region 320 into two parts: a white part and a non-white part. The Otsu's thresholing may be employed to choose the optimum threshold. Certain pixels having values above the threshold are considered that fall into the white part while the other pixels having values below the threshold are considered that fall into the black part. A histogram equalization algorithm is applied to the two parts respectively to generate the equalized histogram 340. Pixel values of the eye region 320 are adjusted with reference made to the equalized histogram 340 to generate the enhanced eye region 320′, and the enhanced eye region 320′ is combined back to generate the enhanced image 300′. An image fusion method may be employed to combine the eye region 320 and the enhanced eye region 320′.

To make the computations less demanding, an eye model may be applied to the segmented eye region 320 so as to locate the position of the pupil. For example, the eye radius may be determined or predefined to define the actual region that will undergo the enhancement processing. The eye radius may be set according to the proportion of the face region to a reference, such as a background object or image size, etc.

Moreover, when the detected object is a face region of a person. The segmentation unit 130 may apply a low pass filter on the pixels of the object. The analysis unit 140 may compute intensity distributions by forming a face map comprising the color values of the face region, and a filtered map comprising filtered color values. The composition unit 150 may map the color values by mapping the color values of the face map to the new color values according to the difference of the face map and the filtered map.

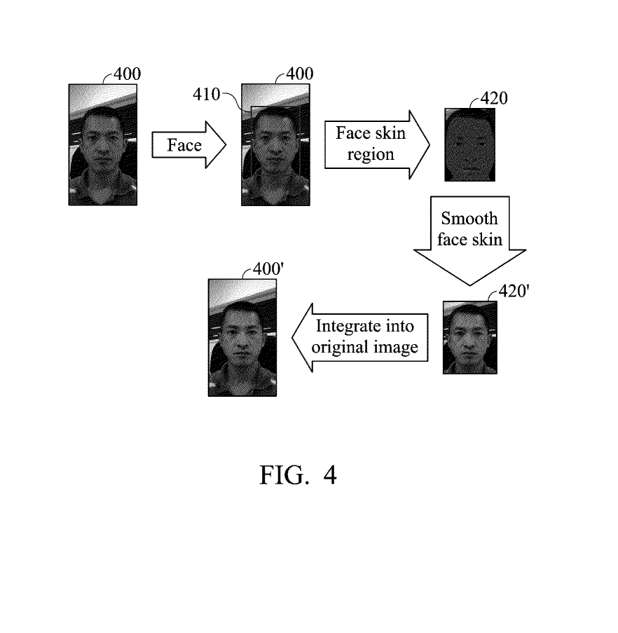

FIG. 4 is a schematic diagram illustrating facial skin enhancement according to an embodiment of the invention. The illustrated embodiment smoothes the skin tone of a face to provide a better look. Similarly, the face region 410 of the still image 400 is detected by a face detection algorithm. The skin sub-region 420 having pixels with flesh color values is then segmented from the face region 410. It should be understood by one with ordinary skill in the art that the skin sub-region 420 may comprise pixels having similar color values or with little variance in between compared with eyes, a mouth, and/or other facial features of the face region 410. The skin sub-region 420 may form a face map O. The face map O may be an intensity distribution computed by the analysis unit 140. A low-pass filter is applied to the color values of the pixels within the skin sub-region 420 to generate a target map T. The low-pass filter may be employed in the segmentation unit 130. After that, a variance map D is obtained by calculating the difference between the face map O and the filtered target map T. The variance map D may be directly computed by subtracting the target map T from the face map O. In some embodiments, the variance map D may be calculated by a similar but different algorithm and the invention is not limited thereto. A smooth map S may be calculated according to the target map T and the variance map D. The smooth map S may be calculated as follows:

S=T+αD (6)

where α is a predetermined scaling factor. Each of the maps may comprise information regarding the pixel coordinates and the pixel values. The smooth map S is then applied to the original image 400 to produce the skin-smoothed image 400′. An image fusion method may be employed to combine the original image 400 and the smooth map S. The image composition may be implemented by replacing the color values of the pixels in the face map O with the color values of the corresponding pixels in the smooth map S. Although the skin tone smoothing in the embodiment shown, it is understood that alternative embodiments are contemplated, such as applying the face enhancement to a lip, eyebrows, and/or other facial features of the face region. In some embodiments, the low-pass filter and the scaling factor α may be configured by the user. In an example, when a user might wish to filter out visible defects on a face in an image, such as a scar, a scratch mark, etc., the low-pass filter may be configured to filter out such defects. In another example, the low-pass filter may be configured to filter out wrinkles on a face in an image. In addition, the scaling factor α may be set to a different value to provide a different smoothing effect.

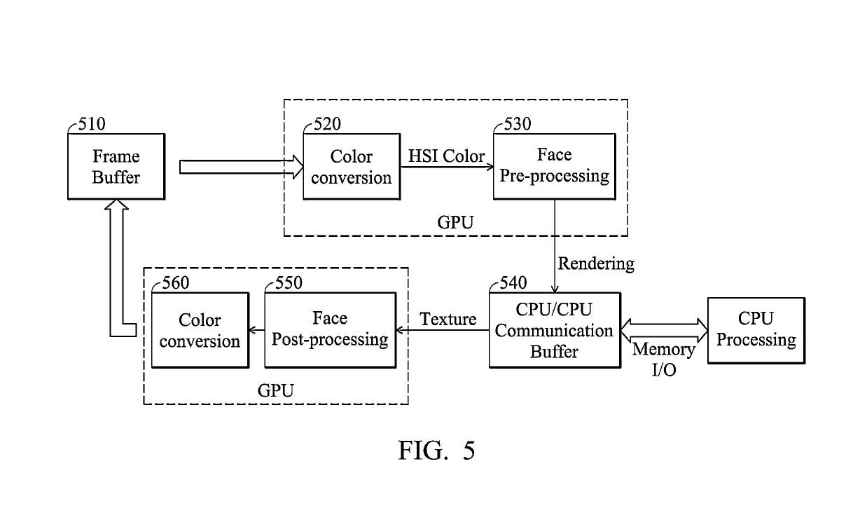

FIG. 5 illustrates the architecture for the hybrid GPU/CPU process model according to an embodiment of the invention. The frame buffer 510 holds a source image containing at least a face. The color format of the source images may vary based on the use case and software/hardware platform, for example, yuv420sp are commonly applied for camera shooting and video recording, where RGB565 are commonly applied for UI (user interface) and still-image decoding. To unify the color format for processing, the system utilizes the GPU to perform the color conversion 520 to convert the color format of the source images into another. Due to the nature of the HSI (hue, saturation and intensity) color format being suitable for face processing algorithms, the source images are converted to HSI color format.

After the color conversion, each source image is sent to the face pre-processing module 530 of the GPU. Two main processes are performed in the module 530: the face map construction and the face color processing. Due to the GPU being designed with parallel pixel manipulation, it gains better performance to perform the two processes by the GPU than by the CPU. The face pre-processing module 530 renders the results into the GPU/CPU communication buffer 540. The face pre-processing module 530 renders the results into the GPU/CPU communication buffer 540. Since the GPU/CPU communication buffer 540 is preserved in a RAM (random access memory) for streaming textures, data stored in the GPU/CPU communication buffer 540 can be accessed by both the GPU and CPU. The GPU/CPU communication buffer 540 may store four channel images, in which each pixel is represented by 32 bits. The first three channels are used to store HSI data and the fourth channel is used to store the aforementioned facial mask information, wherein the facial mask is defined by algorithms performed by the CPU or GPU. The face mask can been seen in 310 of FIG. 3 or 410 of FIG. 4, the fourth channel for each pixel may store a value to indicate if the pixel falls within the facial mask or not.

The data of the GPU/CPU communication buffer 540 is sent to the CPU, and is rendered by the face pre-processing module 530 of the GPU. Since the CPU has a higher memory I/O access rate on RAM and faster computation capability than that of the GPU, the CPU may perform certain pixel computation tasks, such as anti-shining, or others, more efficiently. Finally, after the CPU completes the tasks, the data of the GPU/CPU communication buffer 540 will be sent back to the face post-processing module 550 of the GPU for post-processing, such as contrast enhancement, face smoothing, or others, and the color conversion module 560 of the GPU converts the color format, such as the HSI color format, into the original color format that the source images use, and then renders the adjusted images to the frame buffer 510. The described CPU/GPU hybrid architecture provides better performance and less CPU usage. It is measured that the overall computation performances for reducing or eliminating perspective distortion can be enhanced by at least 4 times over the sole use of the CPU.

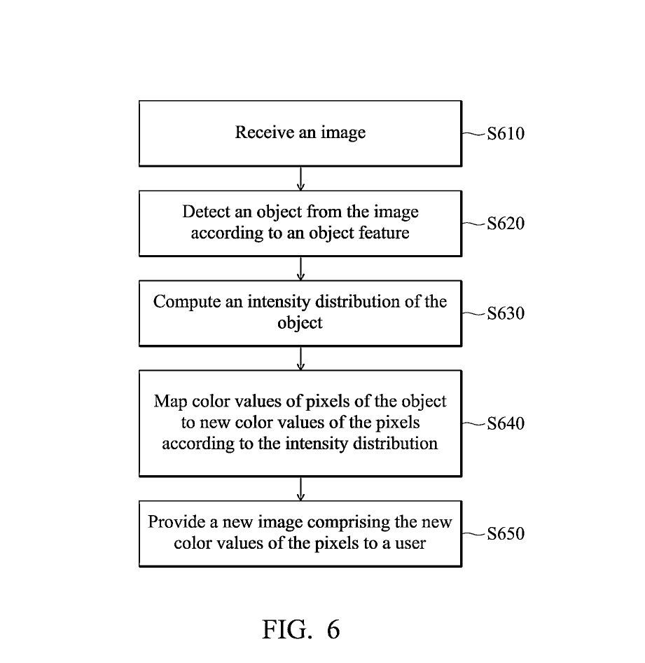

FIG. 6 is a flowchart illustrating an image enhancement method for enhancing an object within an image according to an embodiment of the invention. The process begins to receive an image (step S610). An object, such as an eye region of a face, a face region of a person, or others, is detected from the image according to an object feature (step S620). An intensity distribution of the object is computed (step S630). The intensity distribution may be practiced by a brightness histogram. Color values of pixels of the object are mapped to new color values of the pixels according to the intensity distribution (step S640). The mapping may be achieved by applying a histogram equalization algorithm on two parts of the intensity distribution of the detected object, respectively. A new image comprising the new color values of the pixels is provided to a user (step S650). Examples may further refer to the related description of FIGS. 3 and 4.

In some embodiments, a step for applying a filter, may be a low pass filter, on the pixels of the object between steps S610 and S620. Detailed references of the added steps may be made to the aforementioned description of the segmentation unit 130. Step S630 may be practiced by forming a face map comprising the color values of the detected object, and a filtered map comprising filtered color values. Step S640 may be practiced by mapping the color values of the face map to the new color values according to the difference of the face map and the filtered map. Examples may further refer to the related description of FIG. 4.

Detailed references of steps S610 and S620 may be made to the aforementioned description of the detection unit 120 and the segmentation unit 130. Detailed references of steps S630 and S640 may be made to the aforementioned analysis unit 140. Detailed references of step S650 may be made to the aforementioned composition unit. 150.

While the invention has been described by way of example and in terms of the preferred embodiments, it is to be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An image enhancement method for enhancing an object within an image, comprising:
receiving the image;
detecting the object according to an object feature;
computing an intensity distribution of the object;
mapping a plurality of color values of pixels of the object to a plurality of new color values of the pixels according to the intensity distribution; and
providing a new image comprising the new color values of the pixels to a user.

2. The image enhancement method of claim 1, further comprising:
applying a filter on the pixels of the object.

3. The image enhancement method of claim 1, wherein the object is an eye region of a face, and the computation of the intensity distribution is performed by calculating a brightness histogram of the eye region.

4. The image enhancement method of claim 3, wherein the mapping of the color values is performed by expanding the brightness histogram with respect to a threshold.

5. The image enhancement method of claim 4, wherein the threshold is determined by separating the brightness histogram into two parts by a thresholding algorithm.

6. The image enhancement method of claim 5, wherein the mapping of the color values is performed by applying a histogram equalization algorithm on two parts of the intensity distribution of the eye region, respectively.

7. The image enhancement method of claim 1, wherein the object is a face region of a person, and the computation of the intensity distribution is performed by forming a face map comprising the color values of the face region.

8. The image enhancement method of claim 2, wherein the object is a face region of a person, and the application of the filter is performed by applying a low pass filter on the pixels of the object.

9. The image enhancement method of claim 8, wherein the computation of the intensity distribution is performed by forming a face map comprising the color values of the face region, and a filtered map comprising filtered color values.

10. The image enhancement method of claim 9, wherein the mapping of the color values is performed by mapping the color values of the face map to the new color values according to the difference of the face map and the filtered map.

11. An image enhancement apparatus for enhancing an object within an image, comprising:
a detection unit, configured to receive the image and detect the object according to an object feature;
an analysis unit, coupled to the detection unit, and configured to compute an intensity distribution of the object and map a plurality of color values of pixels of the object to a plurality of new color values of the pixels according to the intensity distribution; and
a composition unit, coupled to the analysis unit and configured to provide a new image comprising the new color values of the pixels to a user.

12. The image enhancement apparatus of claim 11, further comprising:
a segmentation unit, coupled to the detection unit and configured to apply a filter on the pixels of the object,
wherein the analysis unit is coupled to the detection unit via the segmentation unit.

13. The image enhancement apparatus of claim 11, wherein the object is an eye region of a face, and the analysis unit computes the intensity distribution by calculating a brightness histogram of the eye region.

14. The image enhancement apparatus of claim 13, wherein the analysis unit maps the color values by expanding the brightness histogram with respect to a threshold.

15. The image enhancement apparatus of claim 14, wherein the analysis unit determines the threshold by separating the brightness histogram into two parts by a thresholding algorithm.

16. The image enhancement apparatus of claim 15, wherein the analysis unit maps the color values by applying a histogram equalization algorithm on the two parts of the intensity distribution of the eye region, respectively.

17. The image enhancement apparatus of claim 11, wherein the object is a face region of a person, and the analysis unit computes the intensity distribution by forming a face map comprising the color values of the face region.

18. The image enhancement apparatus of claim 12, wherein the object is a face region of a person, and the segmentation unit applies a low pass filter on the pixels of the object.

19. The image enhancement apparatus of claim 18, wherein the analysis unit computes the intensity distribution by forming a filtered map comprising filtered color values.

20. The image enhancement method of claim 19, wherein the composition unit maps the color values by mapping the color values of the face map to the new color values according to the difference of the face map and the filtered map.
